(19) United States
(12) Patent Application Publication
(10) Pub. No.: US 2009/0223479 A1
(43) Pub. Date: Sep. 10, 2009

(54) Inline crankshaft journal

(75) Inventor: Harry Schoell, Pompano Beach, FL (US)

Correspondence Address: ROBERT M. DOWNEY, P.A., 6751 N. FEDERAL HWY., SUITE 300, BOCA RATON, FL, 33487, US

(73) Assignee: Cyclone Power Technologies, Inc.

(21) Appl. No.: 12/074,637

(22) Filed: Mar. 5, 2008

(51) Int. Cl. F16C 3/04

(52) U.S. Cl. 123/197.4

(57) ABSTRACT

A crankshaft and connecting rod configuration for use in piston engines comprises a crankshaft having a separable crank throw wherein the separable crank throw includes a pair of laterally separated throw arms supporting a crankpin therebetween. A pair of coplanar connecting rods is in rotational engagement with the crankpin. Each rod has a small end configured for rotational attachment to a piston and a large end configured for the rotational engagement with the crankpin. At least one retention ring engages a portion of the large end of each connecting rod for maintaining the large ends of the connecting rods in rotational engagement with the crankpin.

### BACKGROUND OF THE INVENTION

1. Field of the Invention

The present invention relates to the journaling of piston connecting rods to crankshafts in general and more particularly to the inline journaling of two connecting rods to a single crankpin of a crankshaft.

2. Discussion of the Related Art

Engines have become a common element in industry and in everyday lives to provide power for operating a wide range of machinery. The most common of these engines are steam and internal combustion piston driven engines. In its simplest form, a piston driven engine comprises one or more pistons that are linearly driven within a substantially closed cylinder by a pressurized gas such as steam or post-combustion gasses. The piston is rotatably connected with one end of a connecting rod with the opposite end of the connecting rod being rotatably connected to a crank throw on a crankshaft. Each crank throw has a crankpin whose axis is offset from that of the crankshaft. The end of the connecting rod opposite from the piston is rotatably connected to the crankpin. In this manner, the cyclical linear motion of the piston causes the connecting rod to rotationally drive the crankpin about the rotational axis of the crankshaft. The linear motion of the piston is thus transformed into the rotational motion of the crankshaft.

Whether engines are of either single- or multi-cylinder design, the power strokes of the individual piston(s) impart a significant side load on the crankshaft. This load is not constant but rather pulses in concert with the power strokes of the pistons thereby also inducing a cyclic and vibrational load to the crankshaft. In engines where all cylinders are in a straight line, the crankshaft becomes relatively long with each cylinder's connecting rod being journaled to a dedicated crank throw with the side load and vibration forces being significant. Various means have been utilized to dampen and counteract these side loads and induced vibration. Multiple bearings are used along the length of the crankshaft to support the crankshaft instead of just one at each end. Counter weights are also built into the crankshaft to impart a degree of rotational stability to the crankshaft and thereby reducing the effects of the side loads and vibration.

By adopting more compact engine configurations such as the “V” orientation of cylinders or of horizontally opposing the cylinders (in lieu of a “straight” orientation), the length of a crankshaft has been able to be shortened thereby reducing the problems inherent with a long crankshaft. In these configurations, the number of crank throws can be halved with corresponding opposite cylinders and their respective connecting rods being journaled to and sharing the same crank throw. In one configuration, substantially identical connecting rods are journaled to the crankpin in a side-by-side configuration where a first connecting rod occupies a position at one end of the crankpin and a second connecting rod occupies a position at the other end of the crankpin. Alternatively, a first of the connecting rods can be forked such that each leg of the fork is journaled to respective outermost ends of the crankpin. The second connecting rod is positioned between the legs of the first connecting rod and is journaled to a middle portion of the crankpin. In this manner, the opposed connecting rods operate in substantially the same plane.

Operation of opposed connecting rods in the same plane such as presented by the forked connecting rod configuration is advantageous to further minimize the vibration effects. However, forked connecting rods are more expensive to fabricate and require more parts and assembly time than the side-by-side connecting rod configuration. Additionally, since all connecting rods are not identical in this configuration with half of the connecting rods being forked and half being of single leg configuration, manufacturers must implement multiple fabrication lines and develop a plurality of tracking procedures with increased inventory which all unnecessarily lead to increased costs. Thus, what is desired is a system of piston engine connecting rods where the individual connecting rods are of identical configuration and where connecting rods journaled to a single crankpin operate in the same plane.

### SUMMARY OF THE INVENTION

The present invention is directed to an inline crankshaft journaling configuration that satisfies the need for opposing connecting rods that load the crankpin in a substantially coplanar manner. The crankshaft and connecting rod configuration for use in piston engines comprises a crankshaft having a separable crank throw wherein the separable crank throw includes a pair of laterally separated throw arms supporting a crankpin therebetween. A pair of coplanar connecting rods is in rotational engagement with the crankpin. Each rod has a small end configured for rotational attachment to a piston and a large end configured for the rotational engagement with the crankpin. At least one retention ring engages a portion of the large end of each connecting rod for maintaining the large ends of the connecting rods in rotational engagement with the crankpin.

Another aspect of the present invention is crankshaft and connecting rod configuration for use in piston engines having a crankshaft with a separable crank throw including a crankpin supported at each end thereof by a throw arm. First and second connecting rods are opposingly positioned with respect to the crankpin, each rod including a small end configured for rotational attachment to a piston and a large end configured for rotational engagement with the crankpin. At least one retention ring engages a portion of the large end of each connecting rod for maintaining the large ends in rotational engagement with the crankpin.

Yet another aspect of the present invention is a connecting rod kit for use in piston engines. The kit includes a pair of connecting rods, each rod having a shaft with a small end at one end of the shaft configured for rotational attachment to a piston and a large end at an opposite end of the shaft. The large end comprising a cannular segment having a concave inner surface and a convex outer surface wherein the cannular segment defines an axis substantially perpendicular to the shaft. The kit further includes at least one retention ring for engaging the convex surface of the large end of each rod such that the cannular segments of each connecting rod are substantially coaxial.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view of a crankshaft and connecting rod journaling arrangement embodying the present invention, wherein two inline connecting rods are journaled to the same crankpin of a crankshaft;

FIG. 2 is a partial cross section of the crankshaft illustrating the connecting rods journaled to the same crankpin;

FIG. 3 is a cross-sectional view of the journaled connection rods shown in FIG. 2 and taken along the line 3-3, FIG. 2.

Like reference numerals refer to like parts throughout the several views of the drawings.

### DETAILED DESCRIPTION OF THE PREFERRED EMBODIMENTS

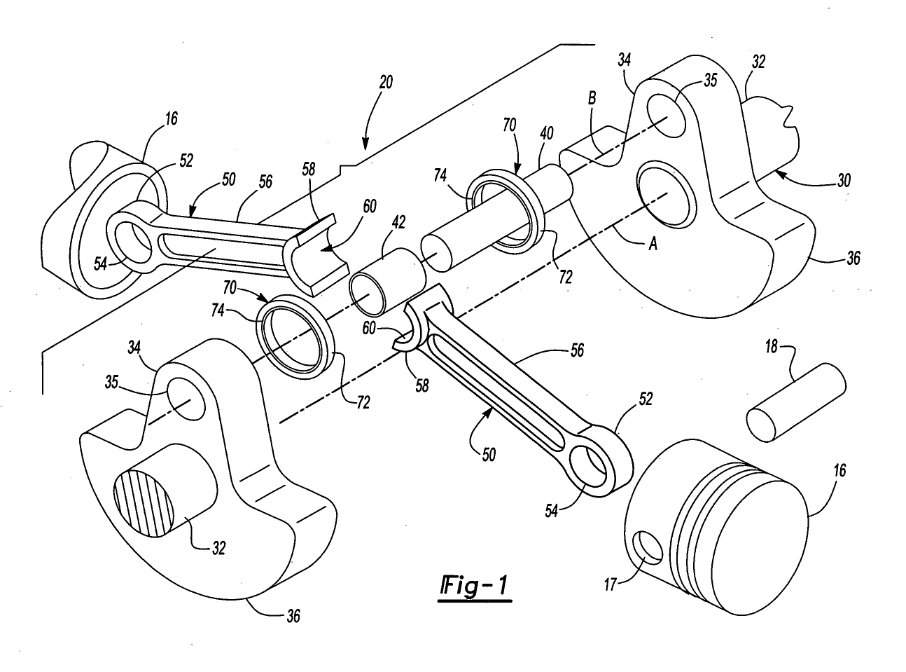

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. While the present invention has been shown and described in accordance with preferred and practical embodiments thereof, one will also recognize that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIG. 1 shows a combined crankshaft and connecting rod configuration 20 which is one of the preferred embodiments of the present invention and illustrates its various components. Crankshaft and connecting rod configuration 20 is intended for use in piston engines. The disclosed configuration 20 is particularly adaptable to engines wherein two pistons 16 are in a substantially horizontally opposed configuration and positioned to act on a single crankpin 40 of crankshaft 30. In general, each piston 16 is rotatably connected through wrist pin 18 to a connecting rod 50. In turn, connecting rods 50 are retained in rotational engagement with crankpin 40 of crankshaft 30 by at least one and preferably two retention rings 70 to transform the linear reciprocation of pistons 16 into the rotation of crankshaft 30.

FIGS. 1-3 illustrate in detail the unique features of crankshaft and connecting rod configuration 20. A crankshaft 30 is supported within an engine (not shown) at journal points 32. Journal points 32 define an axis of rotation “A” about which crankshaft 30 rotates. Crankshaft 30 includes at least one crank throw defined by two throw arms 34 supporting crankpin 40 therebetween. Each throw arm 34 typically includes a counterweight 36 diametrically opposite from crankpin 40 to reduce operational vibration in crankshaft 30 in a manner well known in the industry. As further illustrated in FIGS. 1 and 3, crankpin 40 is separable from throw arms 34 and is thus removable from crankshaft 30 for convenient replacement and ease of assembly of connecting rods 50 to crankpin 40. However, crankpin 40 is closely received in crankpin apertures 35 of throw arms 34 such that crankpin 40 does not rotate in crankpin apertures 35. Crankpin 40 defines throw axis “B”, and as crankshaft 30 rotates about axis “A”, throw axis “B” rotates about axis “A” at a fixed radial distance. This fixed radial distance defines the stroke of piston 16 as is commonly known in the art.

Alternatively, as illustrated in the cross-section of FIG. 4, crankpin 140 can be integrally and rigidly formed with one of throw arms 134 (lower arm) and is thus not separable therefrom. A free end of crankpin 140 is then closely received in an opposing throw arm 134 (upper arm) to define the crank throw to which connecting rods 150 are rotatably assembled. The configuration of connecting rods 150 and other associated features are identical to connecting rods 50. Like features of the configuration of FIG. 3 are like numbered in FIG. 4 preceded by the numeral “1”.

Referring again to FIGS. 1-3, connecting rods 50 have a central shaft 56 of a predefined length to accommodate the desired piston stroke within the engine cylinder (not shown). Connecting rod 50 has a first end (known in the industry as the ‘small’ end) 52 configured for rotational attachment to piston 16. The manner of this attachment is well known in the industry and typically involves wrist pin 18 being non-rotationally affixed in aperture 54 of small end 52 and further wherein wrist pin 18 extends between opposing apertures 17 in piston 16 and freely rotates therein. The second end 58 of connecting rod 50 (known as the ‘large’ end in the industry) is formed as a cannular segment having an inner concave surface 60 and an outer convex surface. Concave surface 60 has a radius that corresponds to the diameter of crankpin 40 so as to permit concave surface 60 to rotate about the surface of crank pin 40. A first friction reduction sleeve 42 can be interposed between crankpin 40 and concave surface 60 to prevent galling and to decrease the friction resulting from the rotation of concave surface 60 with respect to crank pin 40. Sleeve 42 can be fabricated of a soft metal or a plastic resin depending on the particular engine type in which it is incorporated.

Since pistons 16 are substantially in-line and horizontally opposed one to the other, connecting rods 50 are likewise substantially in-line with one connecting rod 50 on one side of crankshaft 30 and the other connecting rod 50 on the opposite side and are identical one to the other. Preferably, shafts 56 of each connecting rod 50 are aligned such that they are co-planar. In this manner, the forces generated by the reciprocal movement of the opposing pistons 16 operate on the same axial position of crankshaft 30 and greatly reduce the asymmetric vibrational aspects of prior art connecting rods positioned in a side-by-side configuration as practiced in the prior art. Thus, cannular segmented large ends 58 of opposed connecting rods 50 are also diametrically opposed one to the other and do not fully encompass the full diameter of crankpin 40.

Retention ring 70 has an inner surface engaging the outer convex surface of cannular segmented large end 58 of both connecting rods 50 to maintain the respective concave surfaces 60 in rotational engagement with crankpin 40. In the most preferred embodiment, a retention ring 70 is positioned at each end of cannular segmented large ends 58 and comprises a ring 72 of high strength material to withstand the cyclic forces transferred between crankshaft 30 and reciprocating pistons 16. Each retention ring 70 also includes an inner friction reduction sleeve 74 of a material similar to friction reduction sleeve 42 on crankpin 40.

Alternatively, retention ring 70 can be comprised of two arcuate segments (not shown) that are fastenable one to the other in a manner similarly practice with respect to the fastening of large ends of connecting rods in the prior art. The arcuate ring segments are thus fastened about the convex surfaces of cannular segmented large ends 58 without requiring the separation of crankpin 40 from one or both throw arms 34 in crankshaft 30 as described above.

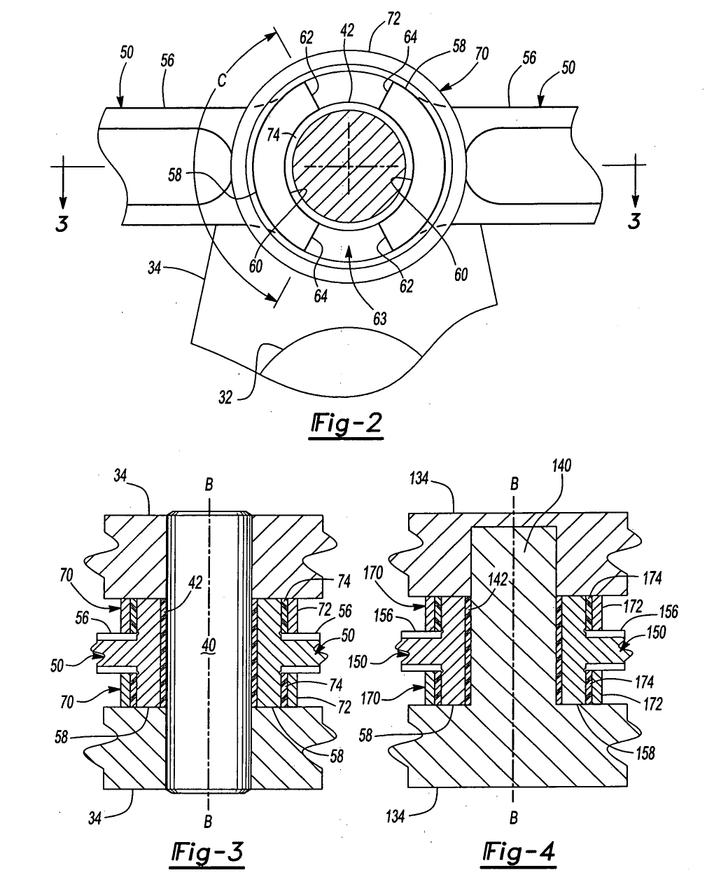

The arcuate measure of each cannularly segmented large end 58 is defined by first and second cannular edges 62 and 64 and is illustrated in FIG. 2 as angle “C”. Angle “C” for each cannularly segmented large end 58 is necessarily less than 180 degrees since the opposing connecting rods rotate about crankpin 40 in opposite directions as crankpin 40 rotates about crankshaft 30 axis “A”. A gap 63 is defined between corresponding cannular edges 62 and 64 of opposed connecting rods 50 thus allowing for the respective rotational movement of each connecting rod 50 without adjacent cannular edges 62 and 64 of opposed segments 58 contacting one another. The maximum angle “C” is a trigonometric function of the radial distance (r) of axis “A” from axis “B” and the effective length (l) of connecting rod 50 (as measured from the axis of wrist pin 18 to axis “B”) and is represented by the equation:

Cmax=2*arc sin(r/l)

To assemble the disclosed crankshaft and connecting rod configuration 20, friction reduction sleeve 42 is sleeved over crankpin 40. Two connecting rods 50 are placed such that their respective concave surfaces 60 are oppositely engaged with the outer surface of friction reduction sleeve 42. A retention ring is sleeved over the convex surfaces of corresponding axial ends of cannular segmented large ends 58 of both connecting rods 50 to maintain concave surfaces 60 in rotational engagement with crankpin 40 and sleeve 42. The ends of crankpin 40 are then pressed into crankpin apertures 35 of throw arms 34.

Alternatively, one end of crankpin 40 can be pressed into crankpin aperture 35 of a first throw arm 34 prior to assembly of connecting rods 50 and thus mirrors the configuration illustrated by FIG. 4 where crankpin 140 is integrally formed with a first throw arm 134. In this configuration, friction reduction sleeve 42 is sleeved over crankpin 40 and a first retention ring is telescoped over the combined crankpin 40 and friction reduction sleeve 42. Two connecting rods 50 are placed such that their respective concave surfaces 60 engage an outer surface of friction reduction sleeve 42. The respective first ends of the opposed cannular segments 58 of both connecting rods 50 at the first retention ring 70 are then pressed into the annular space defined by the inner surface of retention ring 70 and the outer surface of sleeve 42. A second retention ring is then pressed over the convex surfaces of axially opposite ends of cannular segments 58 thereby securing both axial ends of cannular segments 58 in rotational engagement with crankpin 40. The free end of crankpin 40 can then be pressed into the second throw arm 34 thereby completing the crank throw assembly having a coplanar connecting rod configuration.

Those practiced in the art will readily recognize that the above disclosure can be incorporated in steam or internal combustion engines and that an engine incorporating the above disclosure can comprise one or more like configured throws as known in the art where adjacent throws are angularly offset one from the other to facilitate sequential power strokes of the different pistons.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

We/I claim:

1. A crankshaft and connecting rod configuration for use in piston engines comprising:
a crankshaft having a separable crank throw wherein said separable crank throw includes a pair of laterally separated throw arms supporting a crankpin therebetween;
a pair of coplanar connecting rods, each said connecting rod including:
a small end configured for rotational attachment to a piston; and
a large end configured for rotational engagement with said crankpin; and
at least a first retention ring, said retention ring engaging a portion of said large end of each said connecting rod for maintaining said large ends of said connecting rods in rotational engagement with said crankpin.

2. The crankshaft and connecting rod configuration according to claim 1 wherein said crankpin has at least one end separable from one of said throw arms.

3. The crankshaft and connecting rod configuration according to claim 2 wherein said crankpin is separable from each of said throw arms.

4. The crankshaft and connecting rod configuration according to claim 1 wherein each said large end comprises a cannular segment axially aligned with said crankpin and having an inner concave surface and an outer convex surface wherein said inner concave surface is in rotational engagement with said crankpin.

5. The crankshaft and connecting rod configuration according to claim 4 wherein said concave surfaces are substantially opposingly positioned one to the other and coaxial with said crankpin.

6. The crankshaft and connecting rod configuration according to claim 5 wherein each said cannular segment encompasses an arc of less than 180 degrees.

7. The crankshaft and connecting rod configuration according to claim 5 further including a friction reduction sleeve interposed between said crankpin and said concave surfaces.

8. The crankshaft and connecting rod configuration according to claim 5 wherein said retention ring engages said outer convex surfaces of said cannular segments to retain said large ends in rotational engagement with said crankpin.

9. The crankshaft and connecting rod configuration according to claim 8 further including a friction reduction sleeve interposed between said retention ring and said convex surfaces of said cannular segments.

10. The crankshaft and connecting rod configuration according to claim 5 further including a second retention ring wherein said first retention ring engages first axial ends of said cannular segments and said second retention ring engages second opposite axial ends of said cannular segments.

11. A crankshaft and connecting rod configuration for use in piston engines comprising:
a crankshaft having a separable crank throw wherein said separable crank throw includes a crankpin supported at each end thereof by a throw arm;
first and second connecting rods opposingly positioned with respect to said crankpin, each said rod including:
a small end configured for rotational attachment to a piston; and
a large end configured for rotational engagement with said crankpin; and
at least a first retention ring, said retention ring engaging a portion of said large end of each said connecting rod for maintaining said large ends of said connecting rods in rotational engagement with said crankpin.

12. The crankshaft and connecting rod configuration according to claim 11 wherein said crankpin has at least one end separable from one of said throw arms.

13. The crankshaft and connecting rod configuration according to claim 11 wherein each said large end comprises a cannular segment having an inner concave surface and an outer convex surface, said cannular segment being axially aligned with said crankpin.

14. The crankshaft and connecting rod configuration according to claim 13 wherein each said cannular segment encompasses an arc of less than 180 degrees.

15. The crankshaft and connecting rod configuration according to claim 13 wherein said retention ring engages said outer convex surfaces of said cannular segments to retain said concave surfaces of said large ends in rotational engagement with said crankpin.

16. The crankshaft and connecting rod configuration according to claim 15 further including:
a first friction reduction sleeve interposed between said crankpin and said concave surfaces; and
a second friction reduction sleeve interposed between said retention ring and said convex surfaces of said cannular segments.

17. The crankshaft and connecting rod configuration according to claim 13 including a second retention ring wherein said first retention ring engages first axial ends of said cannular segments and said second retention ring engages second opposite axial ends of said cannular segments.

18. A connecting rod kit for use in piston engines, said connecting rod kit comprising:
a pair of connecting rods, each connecting rod having:
a shaft;
a small end at one end of said shaft and configured for rotational attachment to a piston;
a large end at an opposite end of said shaft and comprising a cannular segment having a concave inner surface and a convex outer surface, said cannular segment defining an axis substantially perpendicular to said shaft; and
at least one retention ring for engaging said convex surface of each said large end such that said cannular segments of each said connecting rod are substantially coaxial.

19. The connecting rod kit according to claim 18 further including a first friction reduction sleeve for bearing against said concave surfaces, and wherein said retention ring includes an inner second friction reduction sleeve for bearing against said convex surfaces.

20. The connecting rod kit according to claim 18 wherein said retention ring comprises first and second arcuate segments, said first and second arcuate segments fastenable one to the other to form a circular ring.
